(19) United States
(12) Patent Application Publication
(10) Pub. No.: US 2026/0139901 A1
(43) Pub. Date: May 21, 2026

(54) DRYING FURNACE

(71) Applicant: NGK INSULATORS, LTD., Nagoya-shi (JP)

(72) Inventors: Kenshin KITOH, Nagoya-shi (JP); Yoshio KONDO, Nagoya-shi (JP); Tsutomu ITO, Konan-shi (JP)

(21) Appl. No.: 19/447,599

(22) Filed: Jan. 13, 2026

Related U.S. Application Data
(63) Continuation of application No. PCT/JP2023/026077, filed on Jul. 14, 2023.

(51) Int. Cl. F26B 25/22; F26B 3/02; F26B 3/30; F26B 21/37

(52) U.S. Cl. CPC F26B 25/22; F26B 3/02; F26B 3/30; F26B 21/37

(57) ABSTRACT

A drying furnace includes a furnace body, a heater, and a sensor. The furnace body allows a carrier sheet supporting a coating film to pass through the furnace body. The furnace body includes a light transmission portion. The heater is capable of heating the coating film. The sensor can optically detect a state of the coating film heated by the heater, from a side opposite to the coating film with respect to the light transmission portion via the light transmission portion.

### CROSS-REFERENCE TO RELATED APPLICATIONS

This application is a continuation under 35 U.S.C. 120 of International Application PCT/JP2023/026077 having the International Filing Date of July 14, 2023. The identified application is fully incorporated herein by reference.

### BACKGROUND OF THE INVENTION

### 1. Field of the Invention

The present disclosure relates to a drying furnace.

### 2. Description of the Related Art

In the related art, it has been known to manufacture a film product by drying a coating film. As a drying apparatus for such a coating film, for example, there has been proposed a drying apparatus that includes a drying zone for drying a coating film formed by being applied onto a substrate and generates an airflow in parallel to a conveying direction of the coating film (see, for example, Patent Literature 1).

In recent years, applications of film products have diversified, and it has been desired to precisely control the properties of the film product in accordance with the applications. However, when the coating film is dried by the drying apparatus as described in Patent Literature 1, problems arise in that it is difficult to check the state of the coating film in the middle of drying, and variations occur in the properties of the manufactured film product.

### Citation List

### Patent Literature

### [PTL 1] JP 2008-302297 A

### SUMMARY OF THE INVENTION

A primary object of the present disclosure is to provide a drying furnace that can detect a state of a coating film during drying, and can suppress variations in the properties of a film obtained by drying the coating film.

A drying furnace according to an embodiment of the present disclosure includes a furnace body, a heater, and a sensor. The furnace body allows a carrier sheet supporting a coating film to pass through the furnace body. The furnace body includes a light transmission portion. The heater is configured to heat the coating film. The sensor is configured to optically detect a state of the coating film heated by the heater, from a side opposite to the coating film with respect to the light transmission portion via the light transmission portion.

In the drying furnace according to the above-mentioned item [1], the heater may be configured to change output thereof based on a detection result obtained by the sensor.

In the drying furnace according to the above-mentioned item [1] or [2], the heater may be an infrared heater configured to emit infrared rays. The infrared heater may be arranged on the side opposite to the coating film with respect to the light transmission portion.

The drying furnace according to any one of the above-mentioned items [1] to [3] may further include an airflow generation unit. The airflow generation unit is configured to generate an airflow in an internal space of the furnace body.

In the drying furnace according to the above-mentioned item [4], the airflow generation unit may be configured to change a direction and/or an air volume of the airflow based on a detection result obtained by the sensor.

According to the embodiment of the present disclosure, it is possible to achieve a drying furnace that can detect the state of the coating film during drying, and can suppress variations in the properties of the film obtained by drying the coating film.

### BRIEF DESCRIPTION OF THE DRAWINGS

FIG. 1 is a schematic configuration view of a drying furnace according to one embodiment of the present disclosure.

FIG. 2 is a schematic configuration view of a heater included in the drying furnace of FIG. 1.

FIG. 3 is a sectional view of the heater taken along the line III-IIIʹ of FIG. 2.

### DESCRIPTION OF THE EMBODIMENTS

Embodiments of the present disclosure are described below with reference to the drawings. The present disclosure is not limited to those embodiments. In addition, for clearer illustration, some widths, thicknesses, shapes, and the like of respective portions may be schematically illustrated in the drawings in comparison to the embodiments. However, each of the widths, the thicknesses, the shapes, and the like is merely an example, and does not limit the interpretation of the present disclosure.

### A. Overview of Drying Furnace

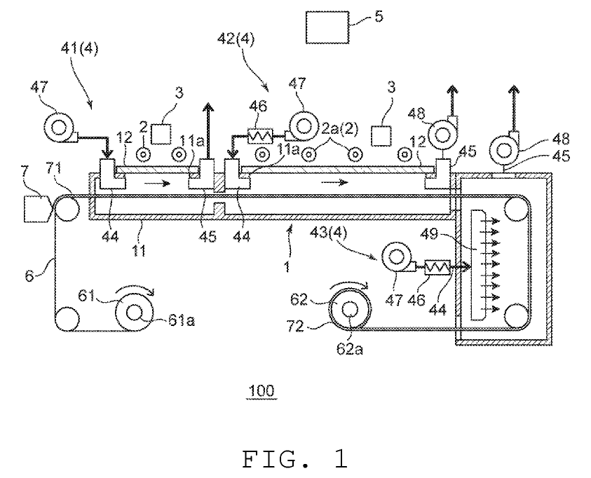

FIG. 1 is a schematic configuration view of a drying furnace according to one embodiment of the present disclosure.

A drying furnace 100 in the illustrated example includes a furnace body 1, a heater 2, and a sensor 3. The furnace body 1 typically has a hollow shape. A carrier sheet 6 supporting a coating film 71 is capable of passing through an internal space of the furnace body 1. The furnace body 1 includes a light transmission portion 12. The heater 2 is capable of heating the coating film 71. The sensor 3 can optically detect a state of the coating film 71 heated by the heater 2 , from a side opposite to the coating film 71 with respect to the light transmission portion 12 via the light transmission portion 12. That is, the sensor 3 is positioned outside the furnace body 1.

With such a configuration, the coating film can be dried by the heater while the state of the coating film passing through the furnace body is optically detected by the sensor positioned outside the furnace body. Accordingly, variations in the properties of the film obtained by drying the coating film can be suppressed.

In one embodiment, the heater 2 is capable of changing its output based on a detection result obtained by the sensor 3. That is, the output of the heater can be adjusted in accordance with the state of the coating film detected by the sensor. Accordingly, drying conditions of the coating film can be appropriately adjusted, and hence a film having desired properties can be stably manufactured.

In one embodiment, the drying furnace 100 further includes an airflow generation unit 4. The airflow generation unit 4 is configured to generate an airflow in the internal space of the furnace body 1. In this manner, the coating film passing through the furnace body can be more smoothly dried.

In one embodiment, the airflow generation unit 4 is capable of changing a direction and/or an air volume of the airflow based on a detection result obtained by the sensor 3. That is, the direction and/or the air volume of the airflow inside the furnace body can be adjusted in accordance with the state of the coating film detected by the sensor. Accordingly, the drying conditions of the coating film can be more appropriately adjusted, and a film having desired properties can be more stably manufactured.

In one embodiment, the drying furnace 100 further includes a control unit 5. Although not shown, the control unit 5 is electrically connected to the sensor 3, and the heater 2 and/or the airflow generation unit 4. The control unit 5 includes, for example, a central processing unit (CPU), a ROM, a RAM, and the like. The control unit 5 is capable of receiving a detection result from the sensor 3, and is capable of transmitting a signal (typically, an electrical signal) based on the detection result to the heater 2 and/or the airflow generation unit 4.

In this embodiment, the heater 2 is configured to change its output in accordance with the signal transmitted from the control unit 5. Further, the airflow generation unit 4 is configured to change the direction and/or the air volume of the airflow in accordance with the signal transmitted from the control unit 5.

Examples of a film 72 to be manufactured by such a drying furnace 100 include: a perovskite semiconductor film that is usable in a photoelectric conversion element; a positive/negative electrode for a lithium ion battery; various ceramic sensors; and a high-performance film.

### Details of the configuration of the drying furnace 100 are described below

### B. Carrier Sheet

The carrier sheet 6 typically has an elongated shape. In the illustrated example, the elongated carrier sheet 6 is movable from an unwinding roll 61 toward a winding roll 62. The carrier sheet 6 passes through the internal space of the furnace body 1 between the unwinding roll 61 and the winding roll 62.

In the unwinding roll 61, the elongated carrier sheet 6 is wound in a roll shape around a rotatable unwinding shaft 61a. The carrier sheet 6 enters the furnace body 1 after being pulled out from the unwinding roll 61. Before the carrier sheet 6 enters the furnace body 1, a coating liquid is applied onto the carrier sheet 6 to form the coating film 71. The coating film 71 formed on the carrier sheet 6 passes through the internal space of the furnace body 1 due to the movement of the carrier sheet 6, to be heated and dried by the heater 2. After that, the coating film 71 is appropriately dried to become the film 72 (dried coating film). The film 72 is discharged from the furnace body 1 while being supported by the carrier sheet 6. The carrier sheet 6 supporting the film 72 is wound in a roll shape around a winding shaft 62a that rotates as a driving force is transmitted thereto, thereby forming the winding roll 62.

In one embodiment, the drying furnace 100 further includes a coating unit 7. The coating unit 7 is positioned upstream of the furnace body 1 in a moving direction of the carrier sheet 6. The coating unit 7 is capable of applying a coating liquid onto the carrier sheet 6. The coating unit 7 can have any appropriate configuration.

The coating liquid includes a material component of the film 72 to be manufactured, and a solvent capable of dissolving and/or dispersing the material component.

When the film 72 is a perovskite semiconductor film, the coating liquid includes a compound represented by the general formula (ABX₃), and a solvent capable of dissolving the compound.

A in the general formula (ABX₃) represents, for example, an organic amino compound or an alkali metal cation.

Examples of the organic amino compound include: alkylamines, such as methylamine, ethylamine, n-butylamine, di-n-butylamine, di-n-hexylamine, trimethylamine, triethylamine, methyl-n-hexylamine, methyldiethylamine, tri-n-hexylamine, and tri-t-butylamine; imidazole; pyrrole; aziridine; carbazole; formamidine; guanidine; aniline; pyridine; 4-t-butylpyridine; phenethylamine; and 5-aminovaleric acid.

The alkali metal cation is a monovalent cation. Examples of the alkali metal include cesium, potassium, and rubidium.

Such As may be used alone or in combination thereof. Of such As, a combination of an organic amino compound and an alkali metal cation is preferred, a combination of an alkylamine, a formamidine, and an alkali metal cation is more preferred, and a combination of a methylamine (MA), a formamidine (FA), and a cesium (Cs) is still more preferred.

When A in the general formula (ABX₃) is a combination of alkylamine (methylamine), formamidine, and an alkali metal (cesium), the molar ratio of the alkylamine to 1 mole of the alkali metal is, for example, from 1 to 5, and the molar ratio of the formamidine to 1 mole of the alkali metal is, for example, from 14 to 18.

B in the general formula (ABX₃) represents, for example, a divalent metal cation, and preferably represents, for example, a cation of an element belonging to Group XIV (metal element classified into Group XIV in the periodic table defined by IUPAC in 2019), such as lead or tin.

Such Bs may be used alone or in combination thereof. In addition, B may be mixed with a small amount of a trivalent cation, such as an indium or antimony ion, in addition to the above-mentioned divalent metal cation. Of those Bs, a cation of an element belonging to Group XIV is preferred, and a cation of lead (Pb) is more preferred.

X in the general formula (ABX₃) represents, for example, a halogen atom or an anion source, and preferably represents, for example, a halogen atom. Specific examples of the halogen atom include chlorine, bromine, and iodine.

Such Xs may be used alone or in combination thereof. Of those Xs, a halogen atom is preferred, and a combination of bromine (Br) and iodine (I) is more preferred.

The compound represented by the general formula (ABX₃) is particularly preferably a perovskite compound having the composition of Cs_{0.05}FA_{0.80}MA_{0.15}PbI_{2.68}Br_{0.32} or a perovskite compound having the composition of Cs_{0.05}FA_{0.80}MA_{0.15}PbI_{2.75}Br_{0.25}.

Examples of the solvent capable of dissolving the compound represented by the above-mentioned general formula (ABX₃) include an organic solvent, preferably N,N-dimethylformamide (DMF), dimethyl sulfoxide (DMSO), and 2-methoxyethanol. The media can be used alone or in combination.

### C. Furnace Body

The furnace body 1 typically includes a main body portion 11 and the light transmission portion 12.

The main body portion 11 is a part of the furnace body 1 other than the light transmission portion 12. Examples of a material for the main body portion 11 include any appropriate heat-resistant material. In one embodiment, the main body portion 11 has a sensor opening 11a. The sensor opening 11a is formed in a part opposed to the coating film 71 passing through the inside of the furnace body 1. The main body portion 11 may have one sensor opening 11a or a plurality of sensor openings 11a. In the illustrated example, the main body portion 11 has two sensor openings 11a.

In one embodiment, the light transmission portion 12 is supported by the main body portion 11 so as to close the sensor opening 11a. In this manner, the light transmission portion 12 is opposed to the coating film 71 passing through the inside of the furnace body 1, with a gap in a thickness direction of the coating film 71.

The light transmission portion 12 is typically capable of transmitting light (electromagnetic waves) having a wavelength of from 200 nm to 4,000 nm. The total light transmittance of light having a wavelength of from 200 nm to 3,500 nm at the light transmission portion 12 is, for example, from 10% to 100%.

When the light transmission portion 12 is capable of transmitting visible light having a wavelength of from 360 nm to 830 nm, the sensor 3 can detect a visible change in the coating film 71 via the light transmission portion 12. Further, when the light transmission portion 12 is capable of transmitting infrared rays having a wavelength of from 1.0 μm to 4.0 μm, as described in detail later, with an infrared heater being adopted as the heater 2, infrared rays can be applied onto the coating film 71 passing through the furnace body 1, from outside the furnace body 1 via the light transmission portion 12, and hence the coating film 71 can be dried.

A material for the light transmission portion 12 is desirably a material that transmits electromagnetic waves in the infrared region, and typical examples of the material include quartz glass. Other candidates include sapphire and calcium fluoride. The thickness of the light transmission portion 12 can be set suitably and appropriately.

### D. Sensor

The sensor 3 is positioned in the external space of the furnace body 1. The sensor 3 is positioned on the side opposite to the coating film 71 passing through the inside of the furnace body 1 with respect to the light transmission portion 12. The number of the sensor 3 is not particularly limited. One sensor 3 may be provided for one light transmission portion 12, or a plurality of sensors 3 may be provided for one light transmission portion 12.

The sensor 3 can have any appropriate configuration as long as the sensor 3 is capable of optically detecting the state of the coating film 71 passing through the inside of the furnace body 1, via the light transmission portion 12. Examples of the state of the coating film that can be detected by the sensor include the color of the coating film, the temperature of the coating film surface, and the smoothness of the coating film surface. In one embodiment, the sensor 3 is capable of detecting the color of the coating film.

### E. Heater

The heater 2 can have any appropriate configuration as long as the heater 2 is capable of heating the coating film 71 passing through the inside of the furnace body 1. Examples of the heater 2 include an electric heater, an infrared heater, and an ultraviolet lamp.

The heater 2 may be arranged inside the furnace body 1 or may be arranged outside the furnace body 1. Further, the number of the heater 2 is not particularly limited, and is, for example, 1 or more, preferably 2 or more.

In the illustrated example, the heater 2 is an infrared heater 2a capable of emitting infrared rays. The infrared heater 2a is arranged on the side opposite to the coating film 71 passing through the inside of the furnace body 1 with respect to the light transmission portion 12. That is, the infrared heater 2a is arranged outside the furnace body 1. Accordingly, as compared to a case in which the infrared heater is arranged inside the furnace body, the influence of heat on the infrared heater can be reduced, and hence the life of the infrared heater can be extended.

Further, the infrared heater 2a is capable of applying infrared rays onto the coating film 71 passing through the furnace body 1, via the light transmission portion 12, and hence is capable of drying the coating film 71.

In one embodiment, the infrared heater 2a is configured as a wavelength control heater capable of emitting infrared rays with a controlled wavelength. The peak wavelength of the infrared rays emitted by the infrared heater 2a can be adjusted suitably and appropriately in accordance with the absorption wavelength of the solvent contained in the coating film. With infrared rays corresponding to the absorption wavelength of the solvent being emitted by the infrared heater 2a, the coating film can be smoothly dried.

The peak wavelength of the infrared rays is, for example, from 0.5 μm to 4.0 μm, preferably from 1.0 μm to 3.0 μm. The spectral half-width of the infrared rays is, for example, 3.0 μm or less, preferably 1.0 μm or less.

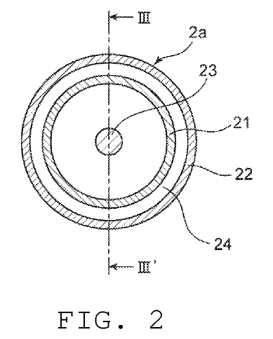

As illustrated in FIG. 2, the infrared heater 2a configured as a wavelength control heater includes, for example, a filament 23, a first tube 21, and a second tube 22.

The application of a voltage enables the filament 23 to apply infrared rays. In the illustrated example, the filament 23 is arranged at the center of the internal space of the first tube 21.

The first tube 21 is arranged in the internal space of the second tube 22. The first tube 21 and the second tube 22 are concentrically arranged so as to share a central axis line. The first tube 21 and the second tube 22 each function as a low-pass filter that absorbs infrared rays exceeding the above-mentioned peak wavelength. Accordingly, the first tube 21 and the second tube 22 each selectively transmit infrared rays having the above-mentioned peak wavelength out of electromagnetic waves radiated from the filament 23.

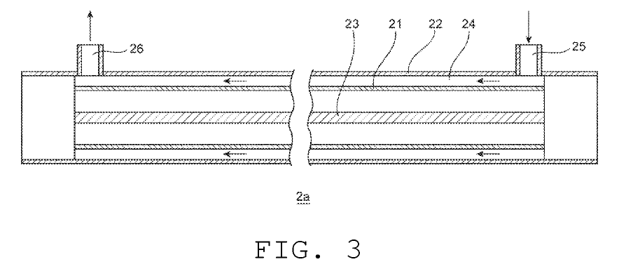

A space between the first tube 21 and the second tube 22 is defined as a flow path 24. A cooling medium, such as air or an inert gas, can pass through the flow path 24. Thus, heat generated in the filament can be suppressed from being released to the outside of the irradiation unit. As illustrated in FIG. 3, after having flowed into the flow path 24 through an inflow portion 25 arranged in the second tube 22, the cooling medium passes through the flow path 24 to be discharged from an outflow portion 26 arranged in the second tube 22.

In one embodiment, such an infrared heater 2a is capable of changing its output based on the detection result obtained by the sensor 3. Typically, the infrared heater 2a receives a signal based on the detection result obtained by the sensor 3, from the control unit 5, and varies the voltage to be applied to the filament 23 in accordance with the signal. In this manner, the output of infrared rays to be emitted can be changed.

### F. Airflow Generation Unit

As illustrated in FIG. 1, the drying furnace 100 may include one airflow generation unit 4 or a plurality of airflow generation units 4. In the illustrated example, the drying furnace 100 includes three airflow generation units 4. In the following, the three airflow generation units 4 may be distinguished as a first airflow generation unit 41, a second airflow generation unit 42, and a third airflow generation unit 43.

In one embodiment, the airflow generation unit 4 includes a first line 44, a second line 45, and a first blower 47.

Each of the first line 44 and the second line 45 is typically a pipe through which a gas is allowed to pass.

In the illustrated example, a first end portion of the first line 44 is positioned inside the furnace body. The first end portion of the first line 44 included in each of the first airflow generation unit 41 and the second airflow generation unit 42 is positioned between the coating film 71 passing through the furnace body 1 and the light transmission portion 12. The first end portion of the first line 44 included in the third airflow generation unit 43 is positioned on a side opposite to the coating film 71 with respect to the carrier sheet 6.

A second end portion of the first line 44 is connected to the first blower 47 outside the furnace body.

A first end portion of the second line 45 is positioned inside the furnace body. The first end portion of the second line 45 included in each of the first airflow generation unit 41 and the second airflow generation unit 42 is positioned between the coating film 71 passing through the furnace body 1 and the light transmission portion 12. The first end portion of the first line 44 and the first end portion of the second line 45 are opposed to each other with a gap in the moving direction of the carrier sheet 6.

When the first end portion of the first line 44 and the first end portion of the second line 45 are arranged to be opposed to each other with a gap in the moving direction of the carrier sheet 6, the airflow generation unit 4 can generate an airflow along the moving direction of the carrier sheet 6.

The first end portion of the second line 45 included in the third airflow generation unit 43 is connected to the furnace body 1 so as to be in communication with an opening formed in the furnace body 1.

The first blower 47 is typically capable of discharging a gas (typically, air). The first blower 47 can have any appropriate configuration.

Further, the airflow generation unit 4 may further include a second blower 48. When the airflow generation unit includes the second blower, an airflow can be generated more stably inside the furnace body. In the illustrated example, the second airflow generation unit 42 and the third airflow generation unit 43 each include the second blower 48. A second end portion of the second line 45 is connected to the second blower 48. The second blower 48 can be described similarly to the first blower 47.

Further, the airflow generation unit 4 may further include a heating element 46. When the airflow generation unit includes the heating element, the temperature of the airflow generated inside the furnace body can be increased. In this manner, the drying environment for the coating film can be appropriately adjusted. In the illustrated example, the second airflow generation unit 42 and the third airflow generation unit 43 each include the heating element 46. The heating element 46 is provided in the first line 44. The heating element 46 is capable of heating the gas passing through the first line 44. The heating element 46 can have any appropriate configuration.

Further, the airflow generation unit 4 may further include a blowing unit 49 having a plurality of air outlets. In the illustrated example, the third airflow generation unit 43 includes the blowing unit 49. The first end portion of the first line 44 is connected to the blowing unit 49. In the blowing unit 49, the gas supplied from the first line 44 passes through the plurality of air outlets to thereby be divided into a plurality of airflows. The blowing unit 49 can have any appropriate configuration.

In one embodiment, those airflow generation units 4 can change the direction and/or the air volume of the airflow based on the detection result obtained by the sensor 3.

When the air volume of the airflow is to be changed, the airflow generation unit 4 typically receives, from the control unit 5 , a signal based on the detection result obtained by the sensor 3, and varies the output of the first blower 47 and/or the second blower 48 in accordance with the signal. In this manner, the air volume of the airflow to be generated inside the furnace body can be appropriately adjusted.

Details of the airflow generation unit 4 capable of changing the direction of the airflow are described in, for example, WO 2013/111647 A1 and JP 6704764 B2. The entire disclosures of those publications are incorporated herein by reference.

When the direction of the airflow is to be changed, the airflow generation unit 4 typically receives, from the control unit 5 , a signal based on the detection result obtained by the sensor 3, and appropriately adjusts the direction of the airflow generated inside the furnace body in accordance with the signal. More specifically, the first airflow generation unit 41 and the second airflow generation unit 42 generate an airflow in the same direction as the moving direction of the carrier sheet 6 (co-current flow), or an airflow in a direction opposite to the moving direction of the carrier sheet 6 (counter-current flow), in accordance with the signal.

The drying furnace according to the embodiment of the present disclosure can be suitably used for manufacturing a film that is applicable to various industrial products.

What is claimed is:

1. A drying furnace, comprising:
a furnace body that allows a carrier sheet supporting a coating film to pass through the furnace body, the furnace body including a light transmission portion;
a heater configured to heat the coating film; and
a sensor configured to optically detect a state of the coating film heated by the heater, from a side opposite to the coating film with respect to the light transmission portion via the light transmission portion.

2. The drying furnace according to claim 1, wherein the heater is configured to change output thereof based on a detection result obtained by the sensor.

3. The drying furnace according to claim 1, wherein the heater is an infrared heater configured to emit infrared rays, and is arranged on the side opposite to the coating film with respect to the light transmission portion.

4. The drying furnace according to claim 1, further comprising an airflow generation unit configured to generate an airflow in an internal space of the furnace body.

5. The drying furnace according to claim 4, wherein the airflow generation unit is configured to change a direction and/or an air volume of the airflow based on a detection result obtained by the sensor.
